(19) United States
(12) Patent Application Publication
(10) Pub. No.: US 2019/0039233 A1
(43) Pub. Date: Feb. 7, 2019

(54) TOOLBOX

(71) Applicant: A.O.K. INDUSTRIAL CO., Taichung (TW)

(72) Inventor: WEI-LIANG LIU, Taichung (TW)

(21) Appl. No.: 15/667,298

(22) Filed: Aug. 2, 2017

(51) Int. Cl. B25H 3/02; E05B 65/52

(52) U.S. Cl. CPC B25H 3/028; E05B 65/52

(57) ABSTRACT

A toolbox includes a casing, at least one drawer, and at least one latch. The casing has a chamber, and a side wall of the casing has at least one side opening communicating with the chamber. The drawer is movably provided in the casing and located in the chamber, and has a recess located at a position corresponding to the side opening of the side wall. The latch is pivotally provided on the side wall of the casing, and has at least one blocking portion. The latch can be operated to pivotally move between a first position and a second position. When the latch is located at the first position, the blocking portion extends into the chamber through the side opening, and enters the recess of the drawer. When the latch is located at the second position, the blocking portion is away from the recess of the drawer.

### BACKGROUND OF THE INVENTION

### 1. Technical Field

The present invention relates to a toolbox, and more particularly to a toolbox with a lockable drawer.

### 2. Description of Related Art

Toolboxes are adapted to be carried with items such as tools or components received therein. A toolbox typically includes a casing and a cover, wherein the casing has a chamber and a top opening communicating with the chamber. The cover is openable and is engaged with the casing to seal the chamber. Objects can be placed in the chamber through the top opening.

A toolbox may further include a plurality of divided boxes provided in the chamber to sort the stored items, which is an efficient way to use the space in the chamber of the casing. However, the cover has to be opened first to take out the items or the divided boxes in the chamber, which is inconvenient.

To solve the problem, some toolboxes are designed to have drawers. Though it is easier to take out items from a toolbox with drawers, the drawers may slide out from the casing when such a toolbox is carried around, dropping the items stored therein as a result.

### BRIEF SUMMARY OF THE INVENTION

In view of the above, the primary objective of the present invention is to provide a toolbox, of which the items stored in a drawer thereof could be easily retrieved, and the drawer could be prevented from sliding out from a casing thereof.

To achieve the objective of the present invention, the present invention provides a toolbox, which includes a casing, at least one drawer, and at least one latch. The casing has a chamber, wherein a side wall of the casing has at least one side opening communicating with the chamber. The at least one drawer is movably provided in the casing and located in the chamber, wherein the at least one drawer has a recess provided on a side thereof, located at a position corresponding to the at least one side opening of the side wall. The at least one latch is provided on the side wall of the casing, wherein the at least one latch has at least one blocking portion, and is adapted to be operated to pivotally move between a first position and a second position. When the at least one latch is located at the first position, the at least one blocking portion extends into the chamber through the side opening, and enters the recess of the at least one drawer; when the at least one latch is located at the second position, the at least one blocking portion is away from the recess of the at least one drawer.

With the latch extending into the recess of the drawer, the movement of the drawer could be restricted, which could prevent the drawer from falling off from the casing.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the toolbox of an embodiment of the present invention;

FIG. 2 is a perspective view of the toolbox of the embodiment of the present invention seen from another direction;

FIG. 3 is a partial exploded view of the toolbox of the embodiment of the present invention;

FIG. 4 is an exploded view, showing the casing of the toolbox of the embodiment of the present invention;

FIG. 5 is a top view of the casing of the toolbox of the embodiment of the present invention;

FIG. 6 is a bottom view of the casing of the toolbox of the embodiment of the present invention;

FIG. 7 is a sectional view along the 7-7 line in FIG. 5;

FIG. 8 is an exploded view, showing the right wall of the casing and the latch of the embodiment of the present invention;

FIG. 9 is a sectional view, showing the latch is located at the first position; and

FIG. 10 is a sectional view, showing the latch is located at the second position.

### DETAILED DESCRIPTION OF THE INVENTION

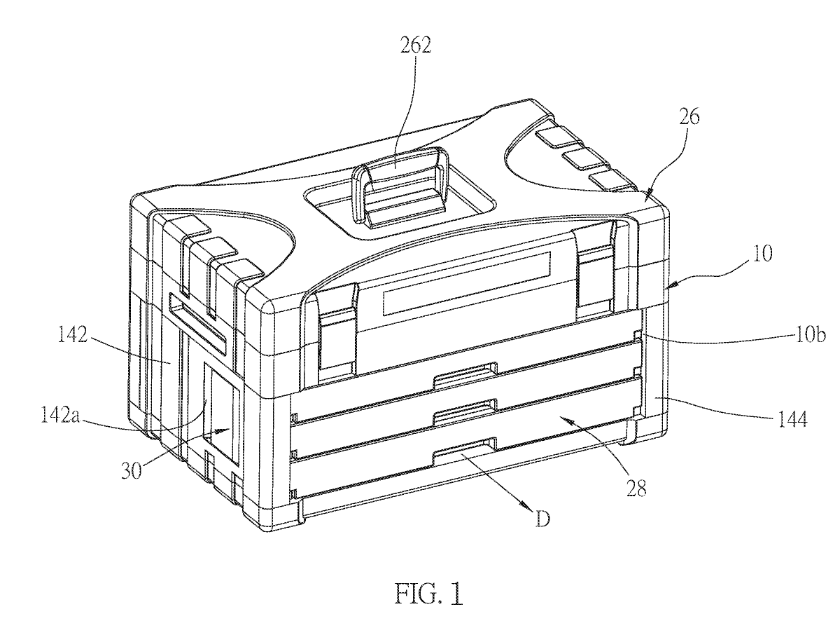

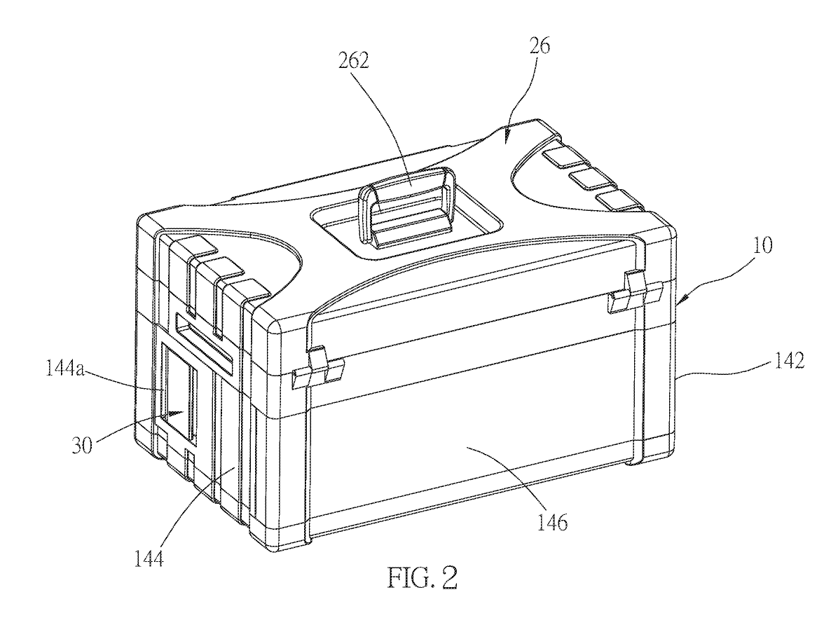

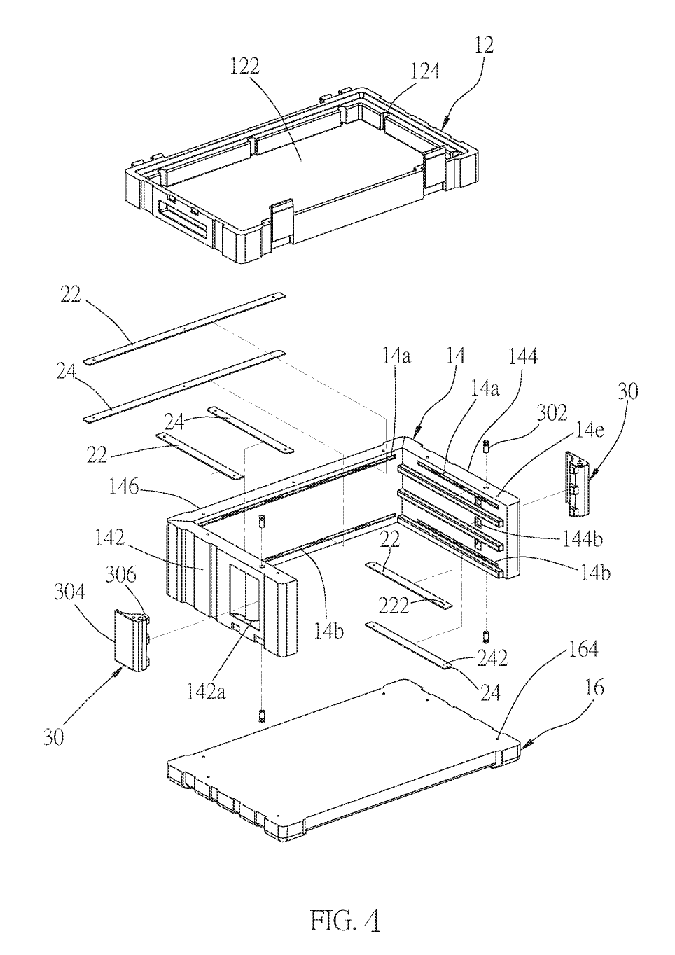

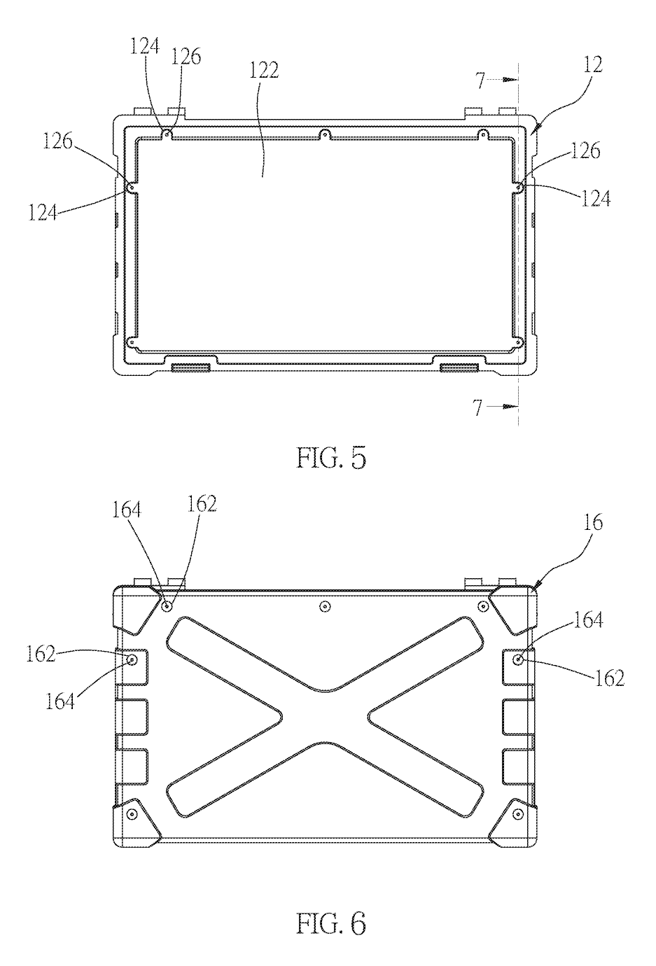

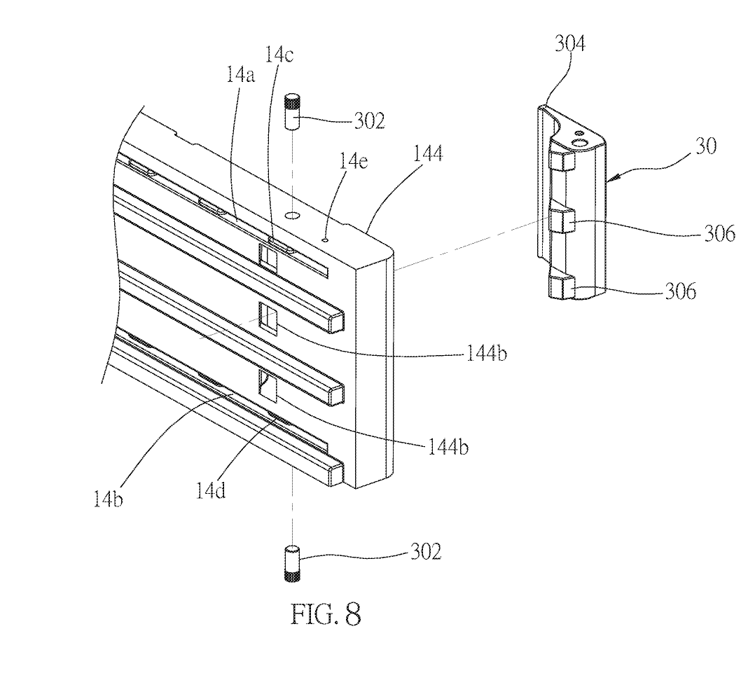

As illustrated in FIG. 1 to FIG. 10, a portable toolbox of an embodiment of the present invention includes a casing 10, a top cover 26, at least one drawer 28, and at least one latch 30.

As shown in FIG. 1 to FIG. 3, the casing 10 has a chamber 10a and a front opening 10b communicating with the chamber 10a, wherein the casing 10 has three side walls, including a left wall 142, a right wall 144, and a rear wall 146. At least one of the left wall 142 and the right wall 144 has a pit. In the current embodiment, both the left wall 142 and the right wall 144 have a pit, wherein the left wall 142 has the pit 142a, while the right wall 144 has the pit 144a. The left wall 142 and the right wall 144 of the casing 10 respectively have at least one side opening 142b, 144b, wherein each of the at least one side opening 142b, 144b communicates with the corresponding pit 142a, 144a and the chamber 10a. In the current embodiment, the at least one side opening 142b, 144b of the left wall 142 and the right wall 144 respectively includes a plurality of side openings 142b, 144b arranged from top down.

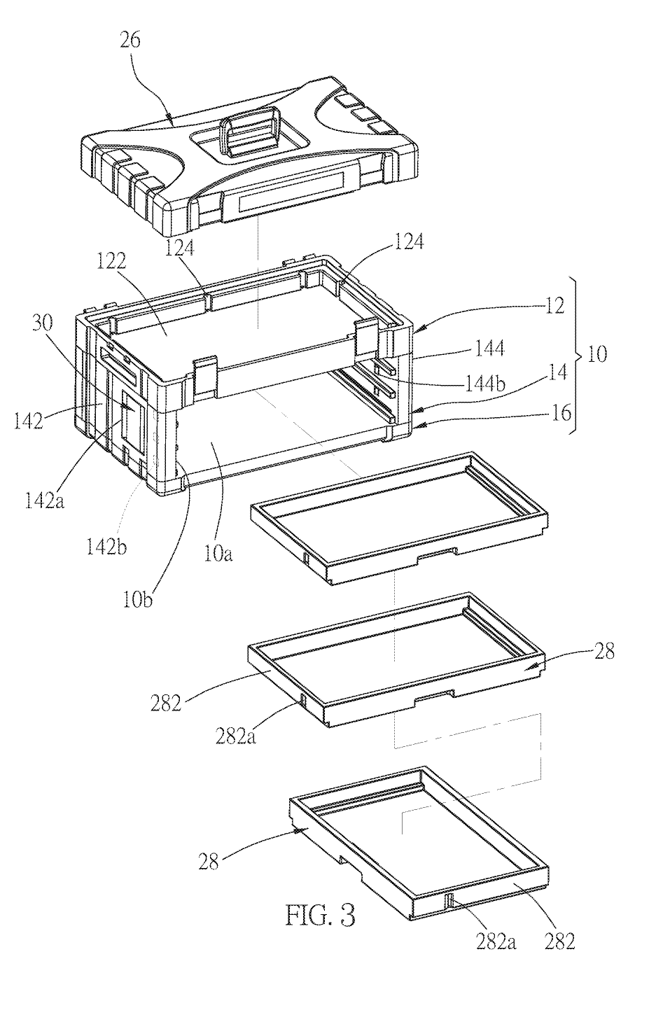

As shown in FIG. 3 to FIG. 7, in the current embodiment, the casing 10 includes an upper layer 12, an middle layer 14, and a lower layer 16, which are made of plastic through blow molding, wherein the upper layer 12 is engaged with the middle layer 14 through a plurality of first pop rivets 18, and the middle layer 14 is engaged with the lower layer 16 through a plurality of second pop rivets 20. The chamber 10a is enclosed by the upper layer 12, the middle layer 14, and the lower layer 16, wherein the middle layer 14 has the left wall 142, the right wall 144, and the rear wall 146.

More specifically, the upper layer 12 has a storage portion 122 recessed therein, and a plurality of grooves 124, wherein the storage portion 122 is long and rectangular; the grooves 124 are provided on three peripheral edges of the storage portion 122, and communicate with the storage portion 122. The grooves 124 are located at positions corresponding to the left wall 142, the right wall 144, and the rear wall 146. The upper layer 12 has a plurality of first through holes 126, each of which goes through a surface of one of the grooves 124 and a bottom surface of the upper layer 12.

A bottom of the lower layer 16 has a plurality of grooves 162 located at positions corresponding to the left wall 142, the right wall 144, and the rear wall 146 (as shown in FIG. 6). In addition, the lower layer 16 has a plurality of second through holes 164, each of which goes through a surface of one of the grooves 162 and a top surface of the lower layer 16.

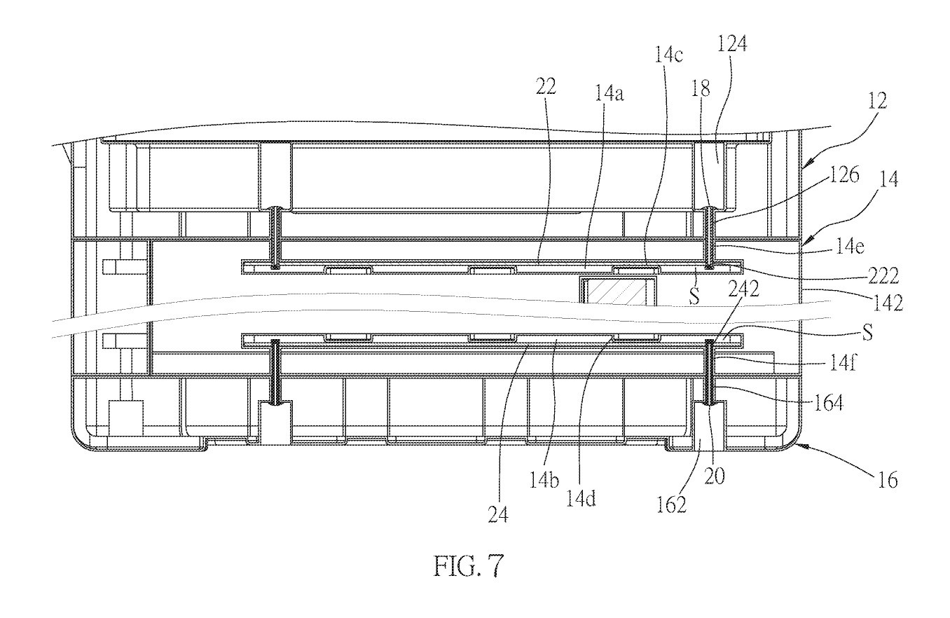

The left wall 142, the right wall 144, and the rear wall 146 of the middle layer 14 are walls of the chamber 10a, wherein each of the walls 142, 144, 146 respectively has a first slot 14a near a top of the middle layer 14, and a second slot 14b near a bottom of the middle layer 14. The left wall 142, the right wall 144, and the rear wall 146 are integrally formed through blow molding. A junction of the rear wall 146 and the left wall 142 and a junction of the rear wall 146 and the right wall 144 are two inclined surfaces contacting each other. Herein we take the right wall 144 as an example for explanation. As shown in FIG. 7, each of the first slots 14a has at least one first protrusion 14c therein. In the current embodiment, the at least one first protrusion 14c includes a plurality of first protrusions 14c, each of which protrudes from bottom up. Each of the second slots 14b has at least one second protrusion 14d. In the current embodiment, the at least one second protrusion 14d includes a plurality of second protrusions 14d, each of which protrudes from top down. The left wall 142, the right wall 144, and the rear wall 146 have a plurality of top perforations 14e and a plurality of bottom perforations 14f, wherein each of the top perforations 14e corresponds to one of the first through holes 126 of the upper layer 12, and goes through the top of the middle layer 14 to communicate with one of the first slots 14a. Each of the bottom perforations 14f corresponds to one of the second through holes 164 of the lower layer 16, and goes through the bottom of the middle layer 14 to communicate with one of the second slots 14b.

Each of the first slots 14a has a first metal plate 22 provided therein, and the first protrusions 14c in each of the first slots 14a abut against a bottom surface of the corresponding first metal plate 22, so that an interval S is formed between the bottom surface of each of the first metal plates 22 and a bottom wall of the corresponding first slot 14a. Whereby, each of the first metal plates 22 is confined in the corresponding first slot 14a, so that the first metal plates 22 would not easily disengage therefrom during the assembling. Each of the first metal plates 22 has at least one perforation 222. In the current embodiment, the at least one perforation 222 includes a plurality of perforations 222 respectively corresponding to the top perforations 14e. Each of the first pop rivets 18 has two ends, wherein one of the ends abuts against the surface of one of the grooves 124 of the upper layer 12. Each of the first pop rivets 18 passes through one of the first through holes 126 of the upper layer 12, one of the top perforations 14e of the middle layer 14, the first slot 14a of the corresponding wall 142, 144, 146, and one of the perforations 222 of the corresponding first metal plate 22. The other one of the ends of each of the first pop rivets 18 is located in the interval S of the corresponding first slot 14a, and abuts against the corresponding first metal plate 22. In this way, the first metal plates 22 could provide a force to abut against the other ends of the first pop rivets 18, so that the upper layer 12 could be engaged with the middle layer 14 more firmly. With the aforementioned design, the first pop rivets 18 are prevented from directly abutting against top walls of the first slots 14a with the other ends thereof, avoiding the top walls of the first slots 14a from deformation which may otherwise cause unstable engagements.

Each of the second slots 14b has a second metal plate 24 provided therein, and the second protrusions 14d in each of the second slots 14b abut against a top surface of the corresponding second metal plate 24, so that an interval S is formed between the top surface of each of the second metal plates 24 and a top wall of the corresponding second slot 14b. Whereby, each of the second metal plates 24 is confined in the corresponding second slot 14b, so that the second metal plates 24 would not easily disengage therefrom during the assembling. Each of the second metal plates 24 has at least one perforation 242. In the current embodiment, the at least one perforation 242 includes a plurality of perforations 242 respectively corresponding to the bottom perforations 14f Each of the second pop rivets 20 has two ends, wherein one of the ends abuts against the surface of one of the grooves 162 of the lower layer 16. Each of the second pop rivets 20 passes through one of the second through holes 164 of the lower layer 16, one of the bottom perforations 14f of the middle layer 14, the second slot 14b of the corresponding wall 142, 144, 146, and one of the perforations 242 of the corresponding second metal plate 24. The other one of the ends of each of the second pop rivets 20 is located in the interval S of the corresponding second slot 14b, and abuts against the corresponding second metal plate 24. In this way, the second metal plates 24 could provide a force to abut against the other ends of the second pop rivets 20, so that the lower layer 16 could be engaged with the middle layer 14 more firmly. With the aforementioned design, the second pop rivets 20 are prevented from abutting against bottom walls of the second slots 14b with the other ends thereof, avoiding the bottom walls of the second slots 14b from deformation which may otherwise cause unstable engagements.

The top cover 26 is openable and is engaged with the upper layer 12, whereby to seal the storage portion 122 and the grooves 124 of the upper layer 12 in an openable manner. The top cover 26 has a handle 262, whereby the toolbox could be lifted through the handle 262. In practice, the top cover 26 could be omitted in other embodiments.

In the current embodiment, the at least one drawer 28 includes a plurality of drawers 28, which are movably provided in the casing 10. In more details, the drawers 28 are located in the chamber 10a, and are arranged vertically. Each of the drawers 28 could be drawn out from the chamber 10a through the front opening 10b in a predetermined direction D, whereby to be disengaged from the casing 10. At least one of two opposite sides 282 of the drawers 28 has a recess provided thereon. In the current embodiment, both the two opposite sides 282 have the recesses 282a, wherein the recess 282a on each of the opposite sides 282 is located at a position corresponding to the side opening 142b, 144b of the corresponding wall (i.e., one of the left wall 142 and the right wall 144) of the casing 10.

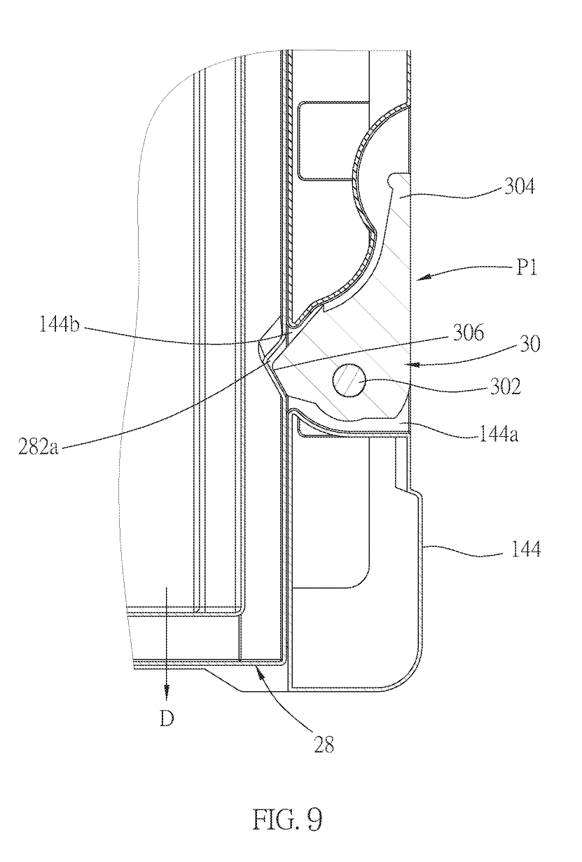

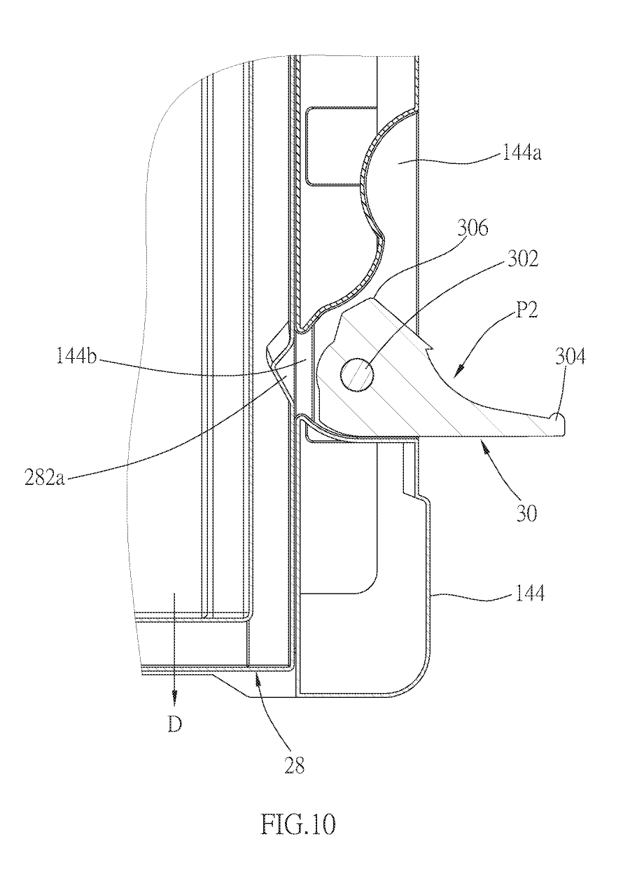

In the current embodiment, the at least one latch 30 includes a plurality of latches 30, wherein each of the latches 30 is pivotally provided on either the left wall 142 or the right wall 144 through two rods 302, and is located in the pit of the corresponding wall 142, 144. Each of the latches 30 has an operable portion 304 and at least one blocking portion 306, wherein the operable portion 304 is adapted to have force exerted thereupon to move the belonged latch 30. In the current embodiment, the blocking portion 306 includes a plurality of blocking portions 306 arranged vertically. The operable portion 304 and the blocking portions 306 of each of the latches 30 are respectively located on two opposite sides of a pivot (i.e., the corresponding pair of rods 302) thereof. Each of the latches 30 could be operated to pivotally move between a first position P1 and a second position P2 (as shown in FIG. 9 and FIG. 10, respectively). Herein we take the latch 30 located on the right wall 144 as an example for explanation. When the latch 30 is located at the first position P1 shown in FIG. 9, each of the blocking portions 306 extends into the chamber 10a through the side opening 144b, and enters the corresponding recess 282a of one of the drawers 28. At the same time, the operable portion 304 is toward the rear side of the toolbox, and the latch 30 is received in the corresponding pit 144a. In this way, the drawers 28 could be restricted from being pulled out. When the latch 30 is located at the second position P2 as illustrated in FIG. 10, each of the blocking portions 306 is away from the recess 282a of the corresponding drawers 28, so that the drawers 28 could be easily pulled out.

It is worth mentioning that, when the latches 30 are located at the first position P1, the operable portion 304 is positioned in a direction opposite to the predetermined direction D, i.e., the direction to draw out the drawers 28, and therefore the drawers 28 would push against the blocking portions 306 from inside of the toolbox when the drawers 28 are moved in the predetermined direction D as being pulled out or due to the toolbox is being moved. As a result, the latches 30 would be restricted from moving to the second position P2. Therefore, with such design, the drawers 28 could be effectively prevented from falling off.

In practice, the side openings 142b, 144b arranged vertically on the left wall 142 and the right wall 144 could be each replaced by one single long and vertical side opening. Furthermore, the recesses 282a of the drawers 28 on each side could communicate with each other to form one single recess. To fit such a design, the blocking portions 306 of the latches 30 which are arranged vertically could be also replaced by one single long and vertical blocking portion on each side. The long blocking portion on each side could pass through the corresponding long side opening and extend into the corresponding single recess to restrict the position of the drawers 28.

In conclusion, in order to improve the convenience in use, the toolbox of the present invention is provided with the drawers 28 which could be pulled out. By providing the latches 30 on the casing 10 to abut against the drawers 28, the drawers 28 could be effectively prevented from falling off. In addition, by using the first pop rivets 18 and the second pop rivets 20 to engage the casing 10 which is formed through blow molding, the toolbox could be lightweight and crash-proof. The first pop rivets 18 and the second pop rivets 20 work with the first metal plates 22 and the second metal plates 24 to make the engagement of the casing 10 firmer.

It must be pointed out that the embodiments described above are only some preferred embodiments of the present invention. All equivalent structures which employ the concepts disclosed in this specification and the appended claims should fall within the scope of the present invention.

1. A toolbox, comprising:
a casing having a chamber, wherein a side wall of the casing has at least one side opening communicating with the chamber;
at least one drawer, which is movably provided in the casing and located in the chamber, wherein the at least one drawer has a recess provided on a side thereof, located at a position corresponding to the at least one side opening of the side wall; and
at least one latch pivotally provided on the side wall of the casing, wherein the at least one latch has at least one blocking portion, and is adapted to be operated to pivotally move between a first position and a second position; when the at least one latch is located at the first position, the at least one blocking portion extends into the chamber through the side opening, and enters the recess of the at least one drawer; when the at least one latch is located at the second position, the at least one blocking portion is away from the recess of the at least one drawer;
wherein the at least one latch has an operable portion adapted to be operated; the at least one blocking portion and the operable portion are respectively located on two opposite sides of a pivot of the at least one latch;
wherein the drawer is movable in the predetermined direction to leave the chamber; when the at least one latch is located at the first position, the operable portion is toward a direction opposite to the predetermined direction;
wherein the side wall of the casing has a pit, and the at least one latch is located in the pit.

2. The toolbox of claim 1, wherein the at least one drawer is movable in a predetermined direction to leave the chamber; when the at least one latch is located at the first position and the at least one drawer is moved in the predetermined direction, the at least one drawer abuts against the at least one blocking portion to restrict the at least one latch from moving to the second position.

3-5. (canceled)

6. A toolbox, comprising:
a casing having a chamber, wherein a side wall of the casing has at least one side opening communicating with the chamber;
at least one drawer, which is movably provided in the casing and located in the chamber, wherein the at least one drawer has a recess provided on a side thereof, located at a position corresponding to the at least one side opening of the side wall; and
at least one latch pivotally provided on the side wall of the casing, wherein the at least one latch has at least one blocking portion, and is adapted to be operated to pivotally move between a first position and a second position; when the at least one latch is located at the first position, the at least one blocking portion extends into the chamber through the side opening, and enters the recess of the at least one drawer; when the at least one latch is located at the second position, the at least one blocking portion is away from the recess of the at least one drawer;
wherein the at least one drawer comprises a plurality of drawers arranged in the chamber in a vertical manner; the at least one side opening of the side wall comprises a plurality of side openings arranged in a vertical manner; the at least one blocking portion of each of the at least one latch comprises a plurality of blocking portions arranged in a vertical manner.

7. A toolbox, comprising:
a casing having a chamber, wherein a side wall of the casing has at least one side opening communicating with the chamber;
at least one drawer, which is movably provided in the casing and located in the chamber, wherein the at least one drawer has a recess provided on a side thereof, located at a position corresponding to the at least one side opening of the side wall; and
at least one latch pivotally provided on the side wall of the casing, wherein the at least one latch has at least one blocking portion, and is adapted to be operated to pivotally move between a first position and a second position; when the at least one latch is located at the first position, the at least one blocking portion extends into the chamber through the side opening, and enters the recess of the at least one drawer; when the at least one latch is located at the second position, the at least one blocking portion is away from the recess of the at least one drawer;
wherein the casing comprises an upper layer, a middle layer, and a lower layer, which are made of plastic through blow molding; the upper layer is engaged with the middle layer through a plurality of first pop rivets, and the middle layer is engaged with the lower layer through a plurality of second pop rivets; the chamber is enclosed by the upper layer, the middle layer, and the lower layer, wherein the middle layer has the side wall.

8. The toolbox of claim 7, wherein the middle layer comprises two further side walls; each of the three side walls of the middle layer respectively has a slot; each of the slots has a metal plate provided therein; each of the metal plates has at least one perforation; each of the first pop rivets has two ends, wherein one of the ends abuts against the upper layer; each of the first pop rivets passes through the upper layer, the slot of one of the side walls, and the perforation of the corresponding metal plate, with the other one of the ends abutting against the corresponding metal plate.

9. The toolbox of claim 7, wherein each of the slots has at least one protrusion; each of the at least one protrusion protrudes from bottom up to abut against a bottom surface of the corresponding metal plate, so that an interval is formed between the bottom surface of each of the metal plates and a bottom wall of the corresponding slot; the other one of the ends of each of the first pop rivets is located in the interval of the corresponding slot.

10. The toolbox of claim 8, wherein the upper layer has a plurality of grooves located at positions corresponding to the side walls; one of the ends of each of the first pop rivets abuts against a surface of one of the grooves.

11. The toolbox of claim 10, further comprising a top cover, which is openable and is engaged with the upper layer; the upper layer has a storage portion; the grooves are located on three peripheral edges of the storage portion, and communicate with the storage portion; the top cover seals the storage portion and the grooves in an openable manner.

12. The toolbox of claim 7, wherein the middle layer comprises two further side walls; each of the three side walls of the middle layer respectively has a slot; each of the slots has a metal plate provided therein; each of the metal plates has at least one perforation; each of the second pop rivets has two ends, wherein one of the ends abuts against the lower layer; each of the second pop rivets passes through the lower layer, the slot of one of the corresponding side walls, and the perforation of the corresponding metal plate, with the other one of the ends abutting against the corresponding metal plate.

13. The toolbox of claim 7, wherein each of the slots has at least one protrusion; each of the at least one protrusion protrudes from top down to abut against a top surface of the corresponding metal plate, so that an interval is formed between the top surface of each of the metal plates and a top wall of the corresponding slot; the other one of the ends of each of the second pop rivets is located in the interval of the corresponding slot.

14. The toolbox of claim 12, wherein a bottom of the lower layer has a plurality of grooves located at positions corresponding to the side walls; one of the ends of each of the second pop rivets abuts against a surface of each of the grooves.
